(19) United States
(12) Patent Application Publication
(10) Pub. No.: US 2024/0402696 A1
(43) Pub. Date: Dec. 5, 2024

(54) VEHICLE DEVELOPMENT SUPPORT SYSTEM

(71) Applicant: SUBARU CORPORATION, Tokyo (JP)

(72) Inventors: Yutaka HIWATASHI, Tokyo (JP); Yuji TANIZAKI, Tokyo (JP); Atsushi UDAGAWA, Tokyo (JP); Tsunehiro WATANABE, Tokyo (JP); Satoshi NARUSE, Tokyo (JP)

(21) Appl. No.: 17/925,096

(22) PCT Filed: Jun. 7, 2021
(86) PCT No.: PCT/JP2021/021649

§ 371 Date: Nov. 14, 2022

(51) Int. Cl. G05B 23/02; G05B 17/02

(52) U.S. Cl. CPC G05B 23/0243; G05B 17/02; G05B 2219/2637

(57) ABSTRACT

A vehicle development support system includes an operation apparatus that outputs an operation signal for an in-vehicle device, in response to an operation input by an operator in a cockpit; an ECU that outputs a control signal for controlling the device in response to the operation signal; a real-time simulator that calculates a physical state quantity for operating the device in response to the control signal to simulate a motion of the device and a vehicle behavior associated with the motion; a synchronization apparatus that synchronizes communication in which the ECU receives a simulation result in the simulator with communication in which the simulator receives the control signal; and a video display apparatus that generates video information for the operator based on the simulation result. The control signal output from the ECU which reflects the simulation result is synchronized with the display in the video display apparatus.

### TECHNICAL FIELD

The invention relates to a vehicle development support system that supports development of vehicles.

### BACKGROUND ART

A system that evaluates the control performance of a vehicle has hitherto been known as an evaluation system used for development of the vehicle. The evaluation of the control performance of a vehicle is performed by a control system composed of an electronic control unit (ECU) that controls the behaviors of an actuator and so on mounted in the vehicle or multiple ECUs. In this evaluation system, a virtual vehicle is composed of an actual machine that is composed of the ECU mounted in the vehicle and a simulator that simulates the behavior of the vehicle based on a vehicle model that is set depending on the actual machine, instead of manufacturing a prototype vehicle. The evaluation system sets various test conditions and control parameters used for controlling the virtual vehicle for the virtual vehicle to evaluate the control performance of the ECU in the virtual vehicle (refer to PTL 1).

### CITATION LIST

### Patent Literature

PTL 1: Japanese Unexamined Patent Application Publication No. 2012-137332

### SUMMARY OF INVENTION

### Technical Problem

In the related art described above, an operation personal computer (PC) sets the multiple test conditions for the virtual vehicle in the simulator and sets the values of the control parameters used for controlling the motion of the virtual vehicle in the ECU in the actual machine to perform an evaluation test.

Since the evaluation test is performed using the conditions set by the operation PC in the related art, it is not possible to evaluate in real time the usability when a driver operates an in-vehicle device during vehicle driving or the working performances of the ECU and the in-vehicle device, which work in response to an operation by the driver.

In order to resolve the problem in the related art, it is an object of the invention to provide a vehicle development support system capable of evaluating in real time the usability when the in-vehicle device is operated during vehicle driving or the working performances of the ECU and the in-vehicle device, which work in response to an operation by the driver.

### Solution to Problem

In order to resolve the above problem, a vehicle development support system according to an embodiment of the invention includes an operation apparatus configured to output an operation signal for an in-vehicle device, which is an evaluation target, in response to an operation input by an operator sitting in a cockpit; an ECU configured to output a control signal for controlling the in-vehicle device in response to the operation signal; a real-time simulator configured to calculate a physical state quantity for operating the in-vehicle device in response to the control signal to simulate a motion of the in-vehicle device and to simulate a vehicle behavior associated with the motion of the in-vehicle device; a synchronization apparatus configured to synchronize communication in which a simulation result in the real-time simulator is input into the ECU with communication in which the control signal is input into the real-time simulator; and a video display apparatus configured to generate video information based on the simulation result in the real-time simulator to display the video information so as to be visually recognized by the operator. The control signal output from the ECU with the simulation result being reflected in the control signal is synchronized with the display in the video display apparatus.

### Advantageous Effects of Invention

A vehicle development support system in an embodiment of the invention is capable of evaluating in real time the usability when an in-vehicle device is operated during vehicle driving or the working performances of an ECU and the in-vehicle device, which work in response to an operation by a driver.

### BRIEF DESCRIPTION OF DRAWINGS

FIG. 1 is an explanatory diagram illustrating the system configuration of a vehicle development support system according to an embodiment of the invention.

FIG. 2 is a block diagram illustrating a flow of signals in the vehicle development support system and illustrating a configuration in which an in-vehicle device controlled by an ECU is disposed in a frame body.

FIG. 3 is a block diagram illustrating a flow of signals in the vehicle development support system.

FIG. 4 is a sequence diagram illustrating signal processing in one control cycle in the respective components in the vehicle development support system.

FIG. 5 is an explanatory diagram illustrating a valuation example using the vehicle development support system (non-operating state).

FIG. 6 is an explanatory diagram illustrating a valuation example using the vehicle development support system (operations of an accelerator pedal and a steering wheel).

FIG. 7 is an explanatory diagram illustrating a valuation example using the vehicle development support system (event creation and a brake pedal operation).

### DESCRIPTION OF EMBODIMENTS

Embodiments of the invention will herein be described with reference to the drawings. The same reference characters in different drawings represent components having the same functions in the following description and a duplicated description of such components is appropriately omitted herein.

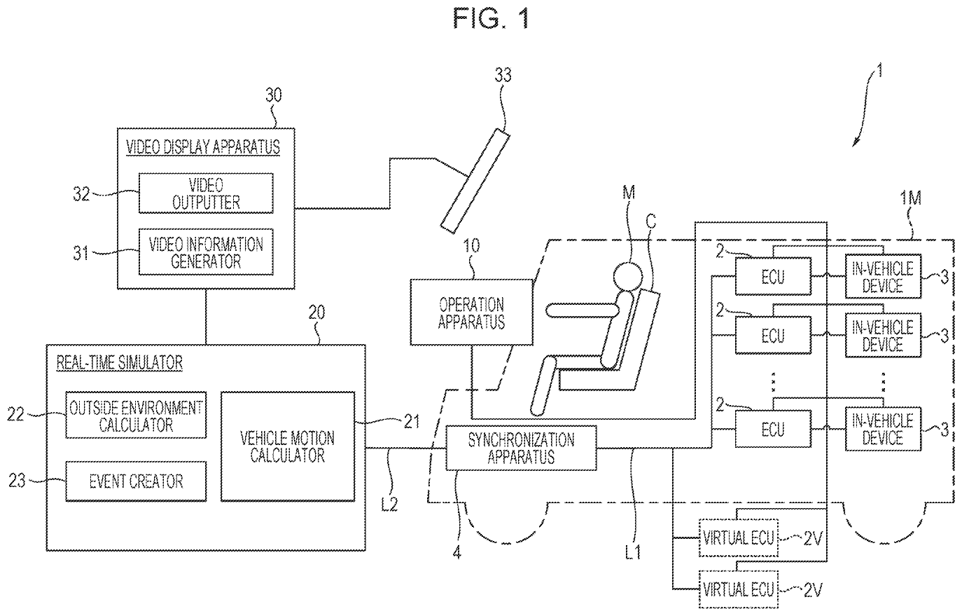

As illustrated in FIG. 1, a vehicle development support system 1 according to an embodiment of the invention builds a system of a closed loop with an intervening operator (person) M who sits in a cockpit C to enable evaluation of the usability of in-vehicle devices or the working performances or the operational performances of the in-vehicle devices working in response to operations by the operator. A person who performs the evaluation (evaluator) may be the operator M or a third party other than the operator M. In addition, an evaluation apparatus (a computer or the like) that performs objective evaluation from a result of detection of an operation or the like of the operator M may be separately provided.

Although an operation with an operation apparatus 10 by the operator M is used in the evaluation of the in-vehicle devices assuming an operation of the operation apparatus 10 described below, the operation apparatus 10 by the operator M is not used when the in-vehicle device with no operation with the operation apparatus 10 is to be evaluated.

The vehicle development support system 1 includes electronic control units (ECUs) 2 mounted in a vehicle and in-vehicle devices 3 controlled by the corresponding ECUs 2. Although an example is illustrated in FIG. 1 in which the vehicle development support system 1 includes the multiple ECUs 2 and the multiple in-vehicle devices 3, the vehicle development support system 1 may include the single ECU 2 and the single in-vehicle device 3 with an evaluation target being specified. The ECU 2 and the in-vehicle device 3 selected from the multiple ECUs 2 and the multiple in-vehicle devices 3 or all the multiple ECUs 2 and all the multiple in-vehicle devices 3 are used as the evaluation targets. The multiple ECUs 2 in the vehicle development support system 1 are connected to each other so as to be capable of communication via a communication line L1 in an in-vehicle network (for example, a controller area network (CAN)), as in an actual vehicle.

The vehicle development support system 1 includes the operation apparatus 10. The operation apparatus 10 outputs an operation signal in response to an operation input by the operator M and transmits the operation signal to the ECU 2 and the in-vehicle device 3, which are the evaluation targets. The operation apparatus 10 includes operation mechanisms of the vehicle (a steering operation mechanism, an accelerator operation mechanism, a brake operation mechanism, a shift operation mechanism, switches for operating the in-vehicle device 3, and so on) and is placed at the position corresponding to that in the actual vehicle the development of which is to be supported. The operation apparatus 10 in the vehicle development support system 1 may be an apparatus resulting from simulation of the operation apparatus mounted in the actual vehicle (for example, an apparatus simply manufactured). The operation apparatus 10 may be provided on a real-time simulator 20 described below, as in the actual vehicle.

The vehicle development support system 1 includes a single virtual ECU 2V or multiple virtual ECUs 2V depending on the usage. The virtual ECU 2V simulates a computerized behavior (computerized control function) of an actual ECU when the actual ECU is mounted in the vehicle, instead of the actual ECU mounted in the actual vehicle, and is capable of being composed of a general-purpose controller, such as rapid control prototyping (RCP), or a PC. Composing, for example, an ECU that is being developed of the virtual ECU 2V enables cooperation of the ECUs in the entire vehicle to be evaluated even during development.

The vehicle development support system 1 includes the real-time simulator 20. The real-time simulator 20 may be composed of a computer including multiple processors and a memory in which programs executed by the processors are stored. The real-time simulator 20 calculates a physical state quantity for operating the in-vehicle device 3 in response to a control signal output from the ECU 2 or the virtual ECU 2V to simulate the motion of the in-vehicle device 3 and to simulate a vehicle behavior in association with the motion of the in-vehicle device 3.

The real-time simulator 20 includes, as its software configuration, a vehicle motion calculator (a vehicle motion calculation model) 21 that calculates the physical state quantities of the in-vehicle device and the vehicle to be controlled to output a simulation result, an outside environment calculator (an outside environment calculation model) 22 that calculates outside environment having an influence on the vehicle behavior to reflect the calculated outside environment in the simulation result, and an event creator (an event creation model) 23 that creates an event for the outside environment to reflect the created event in the simulation result.

The vehicle development support system 1 includes a video display apparatus 30. The video display apparatus 30 is composed of a computer that performs arithmetic processing of video information. The video display apparatus 30 transmits the video information to a display 33 described below to display a video. The simulation result in the real-time simulator 20 is transmitted to the video display apparatus 30.

The video display apparatus 30 generates the video information in accordance with the simulation result in the real-time simulator 20 and displays the generated video information so as to be visually recognized by the operator M. The video display apparatus 30 includes a video information generator 31, which is a program to operate a processor in the video display apparatus 30 to generate the video information, and a video outputter 32, which is a program to operate the processor in the video display apparatus 30 to output the generated video information. A movie or a still image based on the video information output from the video display apparatus 30 is displayed on the display 33.

The vehicle development support system 1 includes a synchronization apparatus 4 that synchronizes communication in which the simulation result in the real-time simulator 20 is input into the ECU 2 with communication in which the control signal from the ECU 2 is input into the real-time simulator 20. The synchronization apparatus 4 is an interface that performs synchronous connection of the communication line L1 at the ECU 2 side and a communication line L2 at the real-time simulator 20 side. The process in which the ECU 2 transmits the control signal is capable of being synchronized with the process in which the real-time simulator 20 transmits the simulation result via the synchronization apparatus 4. One ECU 2 and another ECU 2 in the vehicle development support system 1 are connected to each other so as to be capable of communication via the communication line L1 in the in-vehicle network (for example, the CAN) to realize synchronous communication.

In the vehicle development support system 1 having the above configuration, the cockpit C in which the operator M sits may be placed in a frame body 1M. In this case, part of the in-vehicle devices 3 to be mounted in the vehicle is disposed in the frame body 1M. The in-vehicle devices 3 disposed in the frame body 1M include various sensors and actuators actuating the devices.

In the vehicle development support system 1, for example, the in-vehicle devices in a power train system may be removed from the frame body 1M. However, the vehicle development support system 1 is capable of disposing the ECUs controlling all the in-vehicle devices to be mounted in the actual vehicle, including the in-vehicle devices removed from the frame body 1M, as the ECUs 2 (the actual ECUs) and the virtual ECUs 2V.

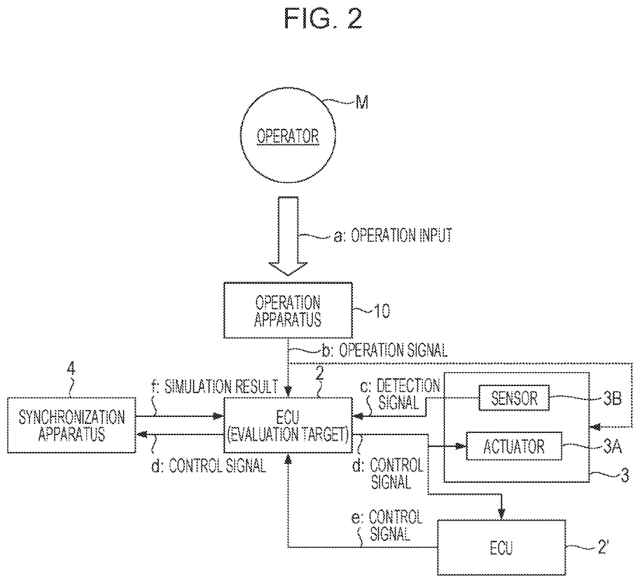

A flow of signals in the vehicle development support system 1 will now be described. FIG. 2 illustrates a case in which the in-vehicle device 3 controlled by the ECU 2, which is the evaluation target, is disposed in the frame body 1M. The in-vehicle device 3 includes an actuator 3A that actuates the device and a sensor 3B that detects the motion of the actuator 3A.

Referring to FIG. 2, when the operator M performs an operation input a with the operation apparatus 10, the operation apparatus 10 inputs an operation signal b into the ECU 2, which is the evaluation target. Depending on the type of the in-vehicle device 3, the operation signal b is input into the in-vehicle device 3, the actuator 3A works in response to the input operation signal b, and a detection signal c by the sensor 3B, which has detected the motion of the actuator 3A, is input into the ECU 2 as an input signal.

The ECU 2 performs arithmetic processing corresponding to the input signal and outputs a control signal d. A closed loop is formed between the ECU 2 and the in-vehicle device 3, in which the actuator 3A works in response to input of the control signal d, the sensor 3B detects the motion of the actuator 3A to transmit the detection signal c to the ECU 2, and the ECU 2 outputs the control signal d based on the detection signal c.

A closed loop is formed between the ECU 2 and another ECU 2′, in which the ECU 2 outputs the control signal d to the other ECU 2′, the other ECU 2′ performs the arithmetic processing corresponding to the control signal d to transmit a control signal e to the ECU 2, and the ECU 2 transmits the control signal d based on the control signal e to the ECU 2′.

Between the ECU 2 and the real-time simulator 20, the control signal d is transmitted to the real-time simulator 20 via the synchronization apparatus 4, the arithmetic processing (for example, a vehicle motion calculation process) corresponding to the control signal d is performed in the real-time simulator 20, and the physical state quantity, which is a simulation result f and on which the motions of the in-vehicle device 3 and the vehicle is based, is transmitted to the ECU 2 via the synchronization apparatus 4.

Here, the control signal d from the ECU 2, which is the evaluation target, is subjected to the arithmetic processing in accordance with the operation signal b, the detection signal c, the control signal e, and the simulation result f and is output. The operation with the operation apparatus 10, the motion of the ECU 2, the motion of the in-vehicle device 3, and the motion of the other ECU 2′ are reflected in the simulation result f in the real-time simulator 20.

The other ECU 2′ is capable of being composed as the ECU 2 into which another operation signal b is input. In this case, the simulation result f in the real-time simulator 20 is transmitted also to the other ECU 2′, as in the ECU 2, and the control signal e is transmitted from the other ECU 2′ to the real-time simulator 20.

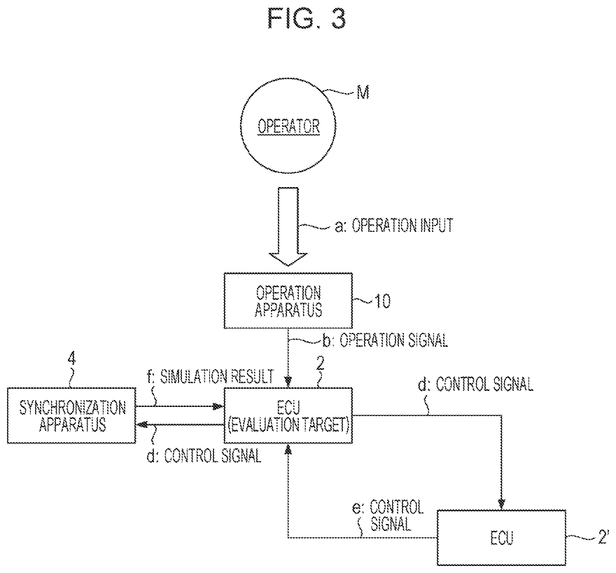

FIG. 3 illustrates a case in which the in-vehicle device 3 controlled by the ECU 2, which is the evaluation target, is not disposed in the frame body 1M. In this case, upon input of the operation signal b associated with the operation input a by the operator M from the operation apparatus 10 into the ECU 2, which is the evaluation target, the ECU 2 outputs the control signal d. The control signal d is transmitted to the other ECU 2′ and is transmitted to the real-time simulator 20 via the synchronization apparatus 4. The closed loop is formed between the ECU 2 and the other ECU 2′, in which the control signal e is returned in response to transmission of the control signal d, as described above, and the closed loop is formed between the ECU 2 and the real-time simulator 20, in which the simulation result f is returned in response to transmission of the control signal d, as described above. Here, the other ECU 2′ may be configured so as to receive the operation signal b and the simulation result f, as described above.

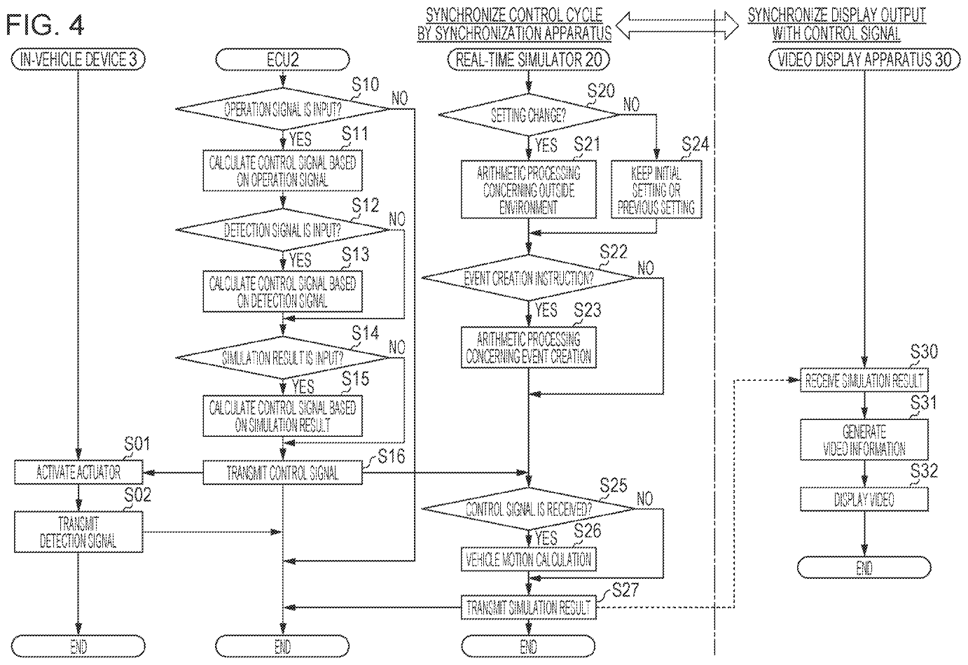

FIG. 4 illustrates signal processing in one control cycle in the respective components in the vehicle development support system 1. Here, since the ECU 2 is connected to the real-time simulator 20 through communication via the synchronization apparatus 4, the processing in each control cycle in the ECU 2 is synchronized with that in the real-time simulator 20. In other words, the ECU 2 is capable of synchronously transmitting and receiving the signal to and from the real-time simulator 20, as in the other ECU connected to the ECU 2 via the in-vehicle network (for example, the CAN).

The ECU 2 determines whether the operation signal b is input in the previous control cycle in each control cycle (Step S10). If the operation signal b is not input in the previous control cycle, the subsequent steps are skipped and the current control cycle is terminated.

The ECU 2 determines whether the detection signal c is input from the sensor 3B in the previous control cycle (Step S12). If the detection signal c is input, the ECU 2 calculates the control signal d based on the detection signal c (Step S13). If the detection signal c is not input, Step S13 is skipped.

The ECU 2 determines whether the simulation result f is input from the real-time simulator 20 in the previous control cycle (Step S14). If the simulation result f is input, the ECU 2 calculates the control signal d based on the simulation result f (Step S15). If the simulation result f is not input, Step S15 is skipped.

Upon calculation of the control signal d in one control cycle, the ECU 2 transmits the calculated control signal d to the in-vehicle device 3 and the real-time simulator 20. Then, the processing in one control cycle is terminated.

Upon reception of the control signal d transmitted from the ECU 2, the in-vehicle device 3 activates the actuator 3A in response to the control signal d (Step S01). The in-vehicle device 3 detects the working state of the actuator 3A with the sensor 3B to transmit the detection signal c to the ECU 2 (Step S02).

The real-time simulator 20 determines whether any setting change is made (Step S20) in the control cycle synchronized with the processing in the ECU 2 described above. If any setting change is made, the real-time simulator 20 performs arithmetic processing concerning the outside environment with the outside environment calculator 22 (Step S21). If no setting change is made, the real-time simulator 20 keeps an initial setting or the previous setting (Step S24).

The real-time simulator 20 determines whether an event creation instruction is issued (Step S22). If the event creation instruction is issued, the real-time simulator 20 performs arithmetic processing concerning event creation (Step S23). If the event creation instruction is not issued, Step S23 is skipped.

The real-time simulator 20 determines whether the control signal d is received (Step S25). If the control signal d is received, the real-time simulator 20 performs vehicle motion calculation corresponding to the control signal d (Step S26). If the control signal d is not received, Step S26 is skipped. The real-time simulator 20 transmits the simulation result f calculated in one control cycle to the ECU 2 (Step S27). Then, the current control cycle is terminated.

As described above, the ECU 2 and the real-time simulator 20 performs the processing in the synchronized control cycles. In contrast, the video display apparatus 30 may not perform the processing synchronized with the control cycles of the ECU 2 and the real-time simulator 20. The video display apparatus 30 synchronizes the control signal d, which is output from the ECU 2 with the simulation result f being reflected in the control signal d, with video display in the video display apparatus 30 at certain timing at which the operator has a sense of realism for the input timing of the operation input a.

In one example, the video display apparatus 30 receives the simulation result f transmitted from the real-time simulator 20 (Step S30). The video display apparatus 30 generates the video information with the video information generator 31 (Step S31). The video display apparatus 30 displays a video on the display 33 with the video outputter 32 (Step S32). At this time, the video display (Step S32) is performed each time the control cycle of the ECU 2 or the real-time simulator 20 is performed multiple times to synchronize the video display by the video display apparatus 30 with the output timing of the control signal d.

With the vehicle development support system 1 having the above configuration, the connection of the ECU 2 to the real-time simulator 20 via the synchronization apparatus 4 causes the real-time simulator 20 to be in a state in which the sensor or the ECU connected to the in-vehicle network is simulated. Information output from the sensor or the ECU, which is not generated unless the vehicle is actually driven, is capable of being generated using the simulation result f in the real-time simulator 20 and the output information is capable of being uploaded on the in-vehicle network. Accordingly, it is possible to operate the ECU 2 and the in-vehicle device 3 in response to an operation with the operation apparatus 10 while simulating a status in which the vehicle is being actually running, to reflect the working states of the ECU 2 and the in-vehicle device 3 in the video in real time, and to evaluate the working performances of the ECU 2 and the in-vehicle device 3 while watching the video.

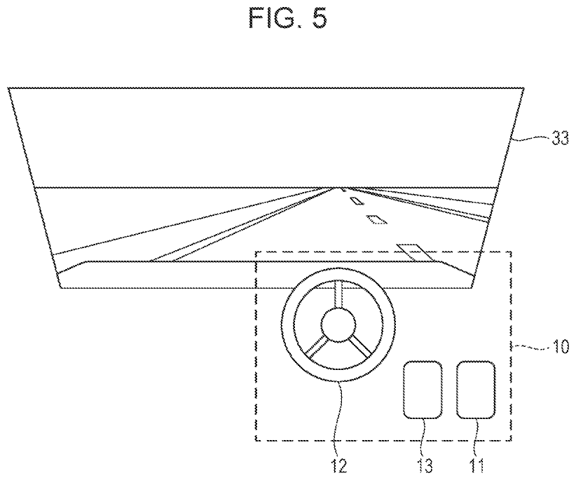

Evaluation examples using the vehicle development support system 1 will be described with reference to FIG. 5 to FIG. 7. Here, cases are exemplified, in which the operator (not illustrated) operates an accelerator pedal 11, a steering wheel 12, and a brake pedal 13 in the operation apparatus 10.

Since the control signal d from the ECU 2 is not transmitted to the real-time simulator 20 in a state in which the operation apparatus 10 is not operated, the real-time simulator 20 performs the calculation in the vehicle motion calculator 21 based on predetermined conditions and transmits the simulation result f in which the set outside environment is reflected to the video display apparatus 30. In this case, as illustrated in FIG. 5, a video based on the simulation result f in which the outside environment that is initially set is reflected (for example, a video of a vehicle stopping state) is displayed on the display 33 of the video display apparatus 30.

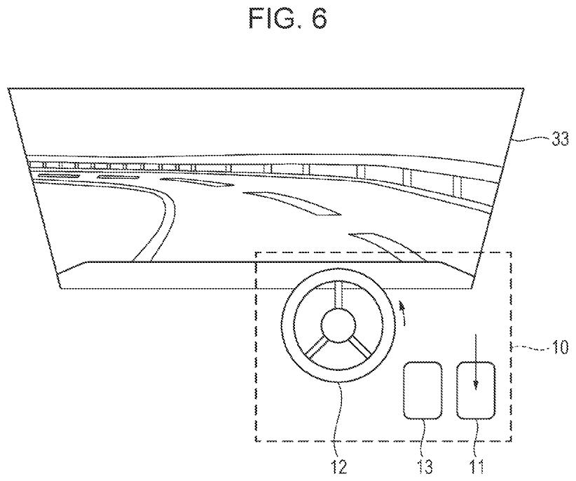

As illustrated in FIG. 6, a case is described, in which the setting of the real-time simulator 20 is changed, a situation in which the vehicle is running on a curved road is set by the outside environment calculator 22 as one example, the operator depresses the accelerator pedal 11 in response to the set situation, and the steering wheel 12 is turned.

In this case, upon depression (the operation input a) of the accelerator pedal 11, the operation signal b is input into one in-vehicle device 3 (for example, electronic gasoline injection (EGI)). The in-vehicle device 3 (EGI) transmits an accelerator position to the ECU 2 (EGI ECU) as the input signal corresponding to the operation signal b. The ECU 2 (EGI ECU) performs arithmetic processing corresponding to the input signal to calculate target engine torque, a target transmission gear ratio, or the like and transmits the calculated target engine torque or target transmission gear ratio to the real-time simulator 20 as the control signal d.

Upon turning (the operation input a) of the steering wheel 12, the operation signal b is input into another in-vehicle device 3 (for example, electronic power steering (EPS). The in-vehicle device 3 (EPS) transmits the input signal corresponding to the operation signal b to the ECU 2 (EPS ECU). The ECU 2 (ESP ECU) calculates assistance torque or the like corresponding to the input signal and transmits the calculated assistance torque or the like to the actuator 3A (an assistance motor) as the control signal d. The control signal d is transmitted to the real-time simulator 20 as a steering angle.

The real-time simulator 20 calculates the physical state quantities of the in-vehicle devices 3 (EGI and EPS) and the vehicle with the vehicle motion calculator 21 based on the control signal d (the target engine torque, the target transmission gear ratio, or the like) from one ECU 2 (EGI ECU) and the control signal d (the steering angle) from the other ECU 2 (EPS ECU) and transmits, for example, the state quantities including engine torque, an engine speed, a vehicle speed, and steering characteristics to the ECUs 2 (EGI ECU and EPS ECU) as the simulation result f.

The ECUs 2 (EGI ECU and EPS ECU) transmit the control signal d, which is based on the input signal corresponding to the variable operation signal b (the amount of depression of the accelerator pedal 11 or the amount of turning of the steering wheel 12) and the simulation result f (the state quantities including the engine torque, the engine speed, the vehicle speed, and the steering characteristics, to the real-time simulator 20. The real-time simulator 20 updates the simulation result f based on the control signal d in which the simulation result f is reflected and outputs the updated simulation result f.

The simulation result f is transmitted to the video display apparatus 30 to be visualized and is displayed on the display 33 so as to be visually recognized by the operator. Displaying the video on the display 33 in synchronization with the output timing of the control signal d enables the operator to visually recognize the video, in which the motions of the ECU 2 and the in-vehicle device 3 associated with the operation with the operation apparatus 10 (the accelerator pedal 11 and the steering wheel 12) and the behavior of the vehicle associated with the motions are reflected, in synchronization with the operation timing with the operation apparatus 10.

Accordingly, the operator operates the operation apparatus 10 (the accelerator pedal 11 and the steering wheel 12), as illustrated in FIG. 6, in accordance with the video of the outside environment displayed on the display 33 and is capable of visually recognizing the video of the vehicle behavior, which is varied in accordance with the operation by the operator, in real time. Consequently, it is possible for the operator to evaluate in real time the working performances of the ECU 2 and the in-vehicle device 3 working in response to the operation with the operation apparatus 10 while simulating the situation in which the operator is actually driving the vehicle during development and to feel the usability when the ECU 2 and the in-vehicle device 3 are caused to work with the operation apparatus 10 in the situation in which the driving of the vehicle is simulated.

In one example, although the steering torque of the EPS is controlled by the vehicle behavior, such as the vehicle speed, the operator is capable of feeling the usability of the steering torque from the steering reaction force of the steering wheel 12 which the operator is operating while felling the vehicle speed, which is varied in response to the depression of the accelerator pedal 11, on the video displayed on the display 33. Accordingly, it is possible to evaluate the steering torque characteristics of the EPS corresponding to the vehicle speed change in real time.

Not only the situation of running on the curved road, as illustrated in FIG. 6, but also various situations are capable of being set with the outside environment calculator 22 as the outside environment set by the real-time simulator 20 at this time. The vehicle motion calculator 21 in the real-time simulator 20 calculates the physical state quantities of the in-vehicle device and the vehicle, which are the evaluation targets, in consideration of the various situations set by the outside environment calculator 22, and outputs the simulation result f.

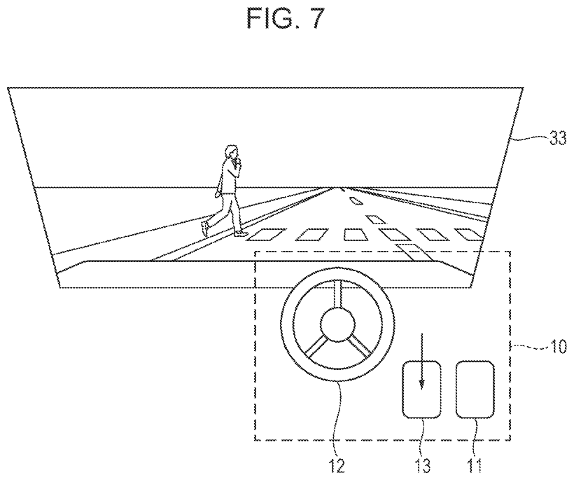

The real-time simulator 20 is capable of creating an event, such a pedestrian or an oncoming vehicle, in the display displayed on the display 33, as illustrated in FIG. 7, by reflecting the arithmetic processing in the event creator 23 in the simulation result f. The creation of such an event is appropriate for, for example, the evaluation of the user-friendliness or the usability of the brake pedal 13 in the operation apparatus 10.

Upon operation of the brake pedal 13 or operation of the steering wheel 12 or the like in response to the operation of the brake pedal 13, the operation signal b is input into the ECUs 2 (for example, ABS ECU, TCS ECU, ESC ECU, and so on) controlling the in-vehicle devices 3 (for example, an anti-lock braking system (ABS), a traction control system (TCS), electronic stability control (ESC), and so on) associated with brake control and the control signal d subjected to the arithmetic processing in these ECUs 2 is transmitted to the real-time simulator 20.

The real-time simulator 20 calculates the physical state quantities of the in-vehicle devices 3 and the vehicle in accordance with the control signal d with the vehicle motion calculator 21 and transmits the state quantities for braking the vehicle to the ECUs 2 and the video display apparatus 30 as the simulation result f. As a result, the ECUs 2 work in association with the simulation result f and the video for braking the vehicle, which results from visualization of the simulation result f, is displayed on the display 33.

At this time, the operator is capable of confirming how the vehicle behaves in response to the motion of the in-vehicle device 3 associated with the brake control, which corresponds to the operation of the brake pedal 13, caused by an event that is crated, while watching the video displayed on the display 33. Although the behavior of the vehicle associated with the brake control is greatly varied depending on the road surface state and so on, the real-time simulator 20 is capable of setting various road surface states and so on with the outside environment calculator 22 to calculate the simulation result f. Accordingly, it is possible to evaluate the performance of the brake control in various situations through video experience while appropriately varying the road surface states and so on to be set.

The vehicle development support system 1 is capable of adopting not only the ECU 2 and the in-vehicle device 3 varying the vehicle behavior by their own motions described above but also all of the ECUs 2 and the in-vehicle devices 3 that are mounted in the vehicle as the evaluation targets. For example, the ECU 2 (AFS ECU) for an adaptive front-lighting system (AFS) automatically varies its orientation pattern depending on not only the operation input a with the operation apparatus 10 but also various running environments (curve running, city running, high-speed running, rainy running, and so on). The ECU 2 (AFS ECU) is capable of visualizing and visually evaluating the orientation patterns in the various situations by inputting the simulation result f, which is the physical state quantities calculated in the vehicle motion calculator 21 and the outside environment calculator 22 in the real-time simulator 20, into the ECU 2 (AFS ECU) and receiving the control signal d from the ECU 2 (AFS ECU).

The vehicle development support system 1 is capable of evaluating the ECU 2 and the in-vehicle device 3 with no operation input by the operator in the same manner. For example, a driving assistance system called advanced driver-assistance systems (ADAS) is a control system that assists the driving by the driver through automatic control of the vehicle, instead of the driver. Although the ADAS has functions composed of various in-vehicle devices 3, such as an adaptive cruise control system (ACC), forward collision warning (FCW), an advanced emergency braking system (AEBS), night vision/pedestrian detection (NV/PD), traffic sign recognition (TSR), a lane keeping assist system (LKAS), blind spot monitoring (BSM), and advanced parking assist (APA), and the ECUs corresponding to the in-vehicle devices 3, the motions of these ECUs may not be associated with the operation input by the operator.

Also in such an in-vehicle device 3 (ADAS), it is possible to visualize and evaluate the ADAS performance in various situations by inputting the physical state quantities in which the arithmetic processing in the outside environment calculator 22 and the event creator 23 is reflected and which is calculated by the vehicle motion calculator 21 into the ECU 2 (ADAS ECU) as the simulation result f in the real-time simulator 20 and receiving the control signal d from the ECU 2 (ADAS ECU).

As described above, with the vehicle development support system 1 according to the embodiment of the invention, the usability when the operator operates the in-vehicle device 3 during vehicle driving or the working performances of the ECU 2 and the in-vehicle device 3, which work in response to an operation by the driver, are acquired in real time and the performance is improved in accordance with the usability of the user, while simulating the status in which the vehicle is running, to effectively support the vehicle development.

Since the motions of the ECU 2 and the in-vehicle device 3, which are the evaluation targets, are capable of being visualized to enable visual recognition, it is possible to not only indicate the development status to the operator M sitting in the cockpit C but also share the development status between multiple developers.

In addition, since the motions of the ECU 2 and the in-vehicle device 3 are capable of being evaluated with the video synchronized with the operation input, it is possible improve the working performance including the responsiveness to the operation input based on the actual usability.

Furthermore, the simulation result f is capable of being acquired in various situations with the outside environment or the event to be created being varied and a use case in which the in-vehicle device 3 is appropriately selected from the multiple in-vehicle devices 3 and the selected in-vehicle device 3 is operated in various situations is capable of easily extracted. Accordingly, it is possible to improve the performances of the ECU 2 and the in-vehicle device 3 in many use cases.

Although the embodiments of the invention are described in detail with reference to the drawings, specific configurations are not limited to the embodiments and modifications or the likes in design within the scope of the invention are also included in the invention. The techniques in the above embodiments may be diverted to combine the embodiments unless the objectives, the configurations, and so on are inconsistent to each other.

### Reference Signs List

1 vehicle development support system
1M frame body
2 ECU
2V virtual ECU
3 in-vehicle device
3A actuator
3B sensor
4 synchronization apparatus
10 operation apparatus
11 accelerator pedal
12 steering wheel
13 brake pedal
20 real-time simulator
21 vehicle motion calculator
22 outside environment calculator
23 event creator
30 video display apparatus
31 video information generator
32 video outputter
M operator
C cockpit
L1, L2 communication line

1. A vehicle development support system comprising:
an operation apparatus configured to output an operation signal for an in-vehicle device, which is an evaluation target, in response to receiving an operation input by an operator sitting in a cockpit;
an electronic control unit configured to output a control signal for controlling the in-vehicle device in response to the operation signal;
a real-time simulator configured to calculate a physical state quantity for operating the in- vehicle device in response to the control signal to simulate a motion of the in-vehicle device and to simulate a vehicle behavior associated with the motion of the in-vehicle device;
a synchronization apparatus configured to synchronize communication in which a simulation result in the real-time simulator is input into the electronic control unit with communication in which the control signal is input into the real-time simulator; and
a video display apparatus configured to generate video information based on the simulation result in the real-time simulator to display the video information so as to be visually recognized by the operator,
wherein the control signal output from the electronic control unit with the simulation result being reflected in the control signal is synchronized with the display in the video display apparatus.

2. The vehicle development support system according to claim 1,
wherein the electronic control unit is communicably connected to another electronic control unit through communication, and
wherein the simulation result is input into the electronic control unit via the synchronization apparatus and a control signal output from the other electronic control unit is input into the real-time simulator via the synchronization apparatus.

3. The vehicle development support system according to claim 1,
wherein the real-time simulator is configured to calculate outside environment influencing the vehicle behavior to reflect the calculated outside environment in the simulation result.

4. The vehicle development support system according to claim 3,
wherein the real-time simulator is configured to create an event for the outside environment to reflect the created event in the simulation result.

5. The vehicle development support system according to claim 1,
wherein the in-vehicle device is mounted in a frame body provided with the cockpit.

6. The vehicle development support system according to claim 1,
wherein the electronic control unit includes a virtual electronic control unit that simulates an electronic behavior of an electronic control unit to be mounted in a vehicle.

7. A vehicle development support system comprising:
electronic control units configured to be mounted in a vehicle;
a real-time simulator configured to simulate a motion of an in-vehicle device mounted in the vehicle and a vehicle behavior in response to control signals from the electronic control units;
a synchronization apparatus configured to synchronize communication in which a simulation result in the real-time simulator is input into the electronic control units with communication in which the control signals are input into the real-time simulator; and
a video display apparatus configured to generate video information based on the simulation result in the real-time simulator to display the video information in synchronization with the control signals in which the simulation result is reflected.

8. The vehicle development support system according to claim 2,
wherein the real-time simulator calculates outside environment influencing the behavior of the vehicle to reflect the calculated outside environment in the simulation result.

9. The vehicle development support system according to claim 8,
wherein the real-time simulator creates an event for the outside environment to reflect the created event in the simulation result.

10. The vehicle development support system according to claim 2,
wherein the in-vehicle device is mounted in a frame body provided with the cockpit.

11. The vehicle development support system according to claim 3,
wherein the in-vehicle device is mounted in a frame body provided with the cockpit.

12. The vehicle development support system according to claim 8,
wherein the in-vehicle device is mounted in a frame body provided with the cockpit.

13. The vehicle development support system according to claim 2,
wherein the electronic control unit includes a virtual electronic control unit that simulates an electronic behavior of an electronic control unit to be mounted in a vehicle.

14. The vehicle development support system according to claim 3,
wherein the electronic control unit includes a virtual electronic control unit that simulates an electronic behavior of an electronic control unit to be mounted in a vehicle.

15. The vehicle development support system according to claim 8,
wherein the electronic control unit includes a virtual electronic control unit that simulates an electronic behavior of an electronic control unit to be mounted in a vehicle.
